(19) United States
(12) Patent Application Publication
(10) Pub. No.: US 2005/0205119 A1
(43) Pub. Date: Sep. 22, 2005

(54) Ganged pressure and suction switching system

(76) Inventor: Adam Awad, Costa Mesa, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 11/136,957

(22) Filed: May 24, 2005

Related U.S. Application Data
(63) Continuation-in-part of application No. 10/266,529, filed on Oct. 8, 2002.

(51) Int. Cl. B08B 3/00

(52) U.S. Cl. 134/169 A

(57) ABSTRACT

A fluid exchange system provides ganged valves to enable the use of suction to withdraw fluid from a tank leaving the tank with a partial vacuum, and then replacing the fluid in the tank by suction from the tank to a fluid supply vessel. The ganged valve permits the simultaneous directing of suction and liquid flow for both withdrawal and replacement as the ganged valves are moved from one position to another.

### RELATED APPLICATIONS

This is a continuation-in-part application of a prior filed and currently pending application having Ser. No. 10,266,529 filed on Oct. 8, 2002 and entitled, “Apparatus and Method for Flushing and Cleaning Engine Lubrication Systems.” This application also relates to pending application Ser. No. 10,640,606, filed on Aug. 12, 2003, and Ser. No. 10,666,583 filed on Sep. 17, 2003, and Ser. No. 10,770,896 filed on Feb. 2, 2004.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

This invention relates generally to automotive radiator flush systems and their methods of use and more particularly to an automated or manually operated system and its method of use and especially to such a system with controls for switching to various modes of operation using ganged valves and gas tight tanks.

2. Description of Related Art

The following art defines the present state of this field:

Cassia, U.S. Pat. No. 5,103,878 describes a flush cap for a vehicle cooling system wherein the flush cap has an inlet through which fresh water enters and an outlet through which dirty coolant leaves. The method employs the flush cap to flush the cooling system of the vehicle. The radiator cap can be adapted to drain a radiator using a hose attached to the outlet of the cap.

Akazawa, U.S. Pat. No. 5,615,716 describes an engine coolant changing apparatus for changing an engine coolant such as LLC (long-life coolant) in an engine coolant path containing a radiator, comprising coolant storing means possessing a pressure action port and a liquid inlet and outlet, detaching mechanism to be attached or detached to or from a filler port of a radiator, communicating device for communicating between the liquid inlet and outlet and the detaching device, and pressure action device for applying a negative pressure to the pressure action port to overheat the coolant to a low temperature by driving an engine when discharging the coolant from an engine coolant system, and applying a positive pressure to the pressure action port when feeding a fresh liquid, so that the coolant can be changed promptly in a short time, without requiring manipulation of radiator drain cock or jack-up of the vehicle.

Turcotte et al., U.S. Pat. No. 5,649,574 describes a removal and refill apparatus for use in removing and/or refilling coolant in an automotive cooling system. The automotive cooling system typically includes a radiator, overflow bottle, engine, water pump, and heater core elements. A method for utilizing the coolant removal and refill apparatus utilizing vacuum and pressure is described for use with the removal and refill apparatus.

Fletcher, Jr. et al., U.S. Pat. No. 5,845,684 describes a clean and easy-to-use, portable upright apparatus, and a method for its use, which can be used to flush and fill the radiator and coolant systems of motorized vehicles in approximately 15 minutes, the apparatus comprising a self-priming pump, a waste collection tank, a tank for holding new or recycled coolant, a filter assembly, and a wheeled support structure for conveniently and efficiently housing the pump, tanks, filter assembly, and the several hoses needed to perform the flush and fill procedure. Applications may include, but are not limited to, flushing coolant from automobile radiators and refilling them with new or recycled coolant.

Klamm, U.S. Pat. No. 6,345,215 describes an apparatus for adding coolant to a cooling system of a motor vehicle including a cap with a resilient sleeve that expands against the inside wall of a radiator filler neck to provide an air-tight connection. A valve attached to the cap controls the flow of air and coolant through the cap. A gauge on the cap indicates the pressure inside the radiator. A venturi assembly connected to the valve provides a source of vacuum for evacuating air from the cooling system. Thereafter, coolant is drawn through the cap by the vacuum created in the system.

Awad, U.S. Pat. No. 6,523,580, describes an apparatus comprising a wheeled cart, and mounted on the wheeled cart a plurality of containers placed in adjacent upright attitudes. A support framework engages the wheeled cart and further provides a support framework engaging an operator's panel with operator's controls. A suction developing device, pressure developing device, conduit switching device, and conduit manifolding device, are enabled for acting together to apply vacuum and pressure exertion on fluids for driving such fluids between the containers and an automotive radiator through a system of conduits.

Awad, U.S. Pat. No. 6,604,557, describes a method of replacing radiator fluid in an automotive radiator including providing two gas tight containers, a fluid conducting hose with a gas tight nozzle fitted into a radiator fill pipe nipple. The method further includes the steps of filling one of the containers with a fresh radiator fluid, drawing a high vacuum on a second one of the containers, drawing spent radiator fluid into the second one of the containers using only suction from the container, thereby leaving the automotive radiator under a partial vacuum and then drawing the fresh radiator fluid, from the first one of the containers, into the radiator using only suction from the partial vacuum in the radiator. A radiator flush step may also be applied following the same method, using two additional containers, one with initial high vacuum and the other containing flush fluid.

Gayet, EP 1013908 describes a coolant fluid replacement device for an automobile, utilizing an open loop distribution circuit within the coolant loop during the replacement of the used coolant. The coolant loop comprises a radiator that includes an inlet from the engine and an outlet to the engine. During the coolant replacement process, the device is connected between the coolant pumps of the vehicle system. The new fluid is stored in a first reservoir. As the new fluid is pumped into the system, the old fluid is forced out into a second reservoir.

The prior art teaches automotive maintenance and especially in the field of radiator fluid replacement, but does not teach the use of ganged control valves for fast switching from withdrawal phase to delivery phase using suction and especially providing of both suction and fluid delivery switching using a ganged valve. The present invention fulfills these needs and provides further related advantages as described in the following summary.

### SUMMARY OF THE INVENTION

In the field of automotive maintenance, the exchange of cooling, lubricating and other fluids is an ongoing necessity. However, the prior art teaches methods that are clearly unsanitary, environmentally undesirable, time consuming and messy. The present apparatus and its method of use provides a distinct improvement in equipment cost and use. Its applications extend from automotive fluid exchange to use in industry in general. A fluid exchange system, mounted on a mobile cart or fixed in place, as on an assembly line, provides ganged valves to enable the use of suction to withdraw fluid from one tank leaving the tank with a partial vacuum, and then replacing the fluid using suction from the tank to a fluid supply vessel. The ganged valve permits the simultaneous directing of suction and liquid flow for both withdrawal and replacement as the ganged valves are moved from one position to another.

The present invention teaches certain benefits in construction and use which give rise to the objectives described below.

A primary objective of the present invention is to provide an apparatus and method of use of such apparatus that provides advantages not taught by the prior art.

Another objective is to provide such an invention capable of moving fluids between storage containers and an automotive radiator with only an initial vacuum drawn on one of the containers.

A further objective is to provide the quick switching from withdrawal of a spent cooling fluid or the like to replacement with a new fluid.

A still further objective is to provide dual switching of pressure or suction along with the moving of a liquid fluid in a fluid exchange system.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIGS. 1, 2 and 3 show a component diagram of a preferred embodiment of the present apparatus;

FIG. 1 shows withdrawal of fluid from a tank in the present system using suction;

FIG. 2 shows replacement of the fluid using residual vacuum in the tank; and

FIG. 3 shows delivery of the withdrawn fluid to a collection tank.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

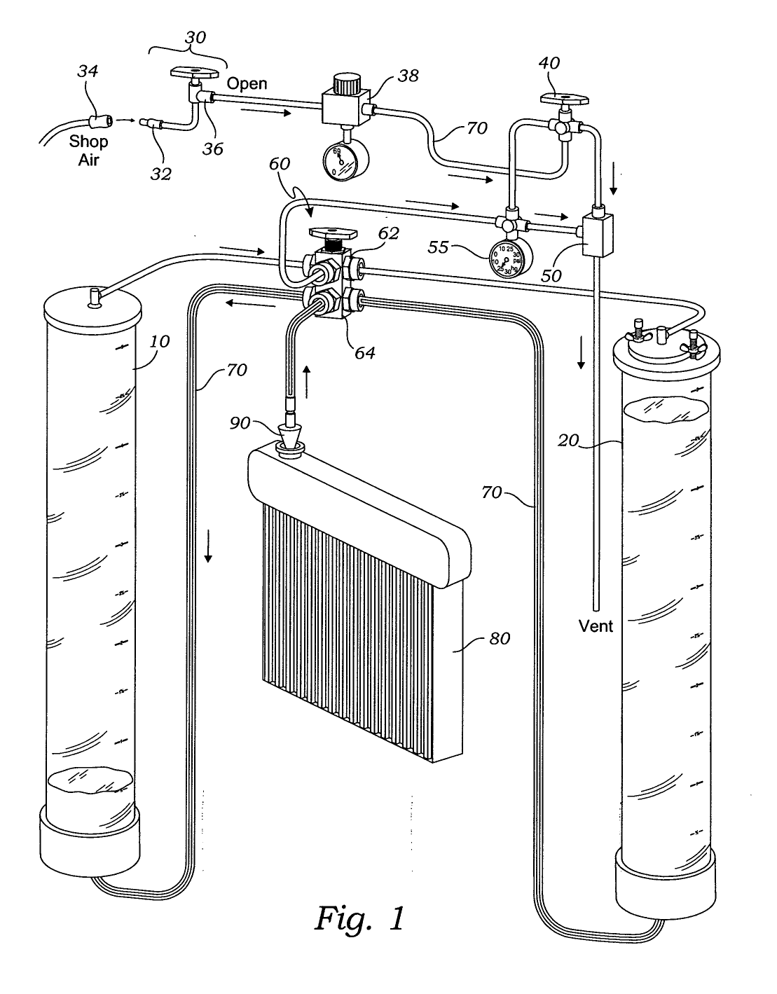

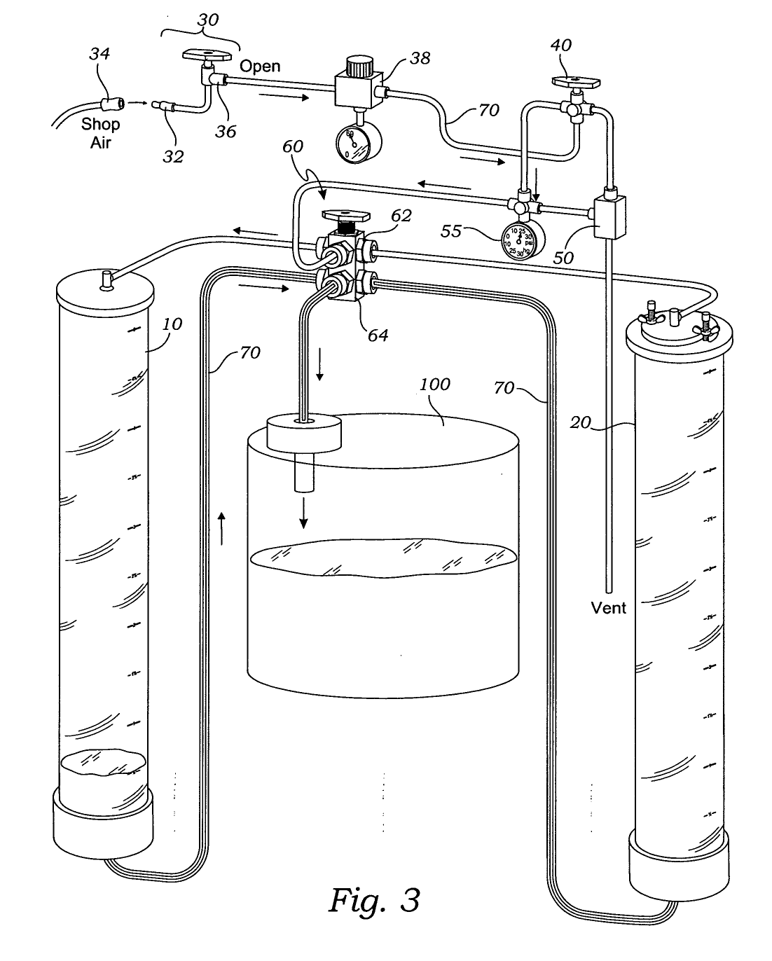

A fluid exchange apparatus comprises components including a receiver tank 10, a discharge tank 20; an air inlet 30, a mode valve 40, a vacuum inductor 50, a dual valve set 60 having an A-valve 62 conductive between alternative first flow paths, and a B-valve 64 conductive between alternative second flow paths. The A-valve 62 and the B-valve 64 are ganged, i.e., joined to move between their respective first and second alternative flow paths simultaneously. A conduit means 70 such as plastic or metal tubing, joins the components 10-60 in the arrangement shown in FIGS. 1-3 and such interconnections of components into a fluid flow system is considered to be known by those of skill in the art. In the figures it is shown that pressurized air is introduced to the system at upper left and enters the system through air inlet 30 preferably comprising a fitting 32 that accepts a hose 34 through which compressed air is delivered to inlet valve 36. Inlet valve 36, in portions of the present method of use, is adjusted to enable air to enter the system. Preferably, a pressure regulator with gauge 38, is made a part of the system in order to adjust the inlet air pressure to a satisfactory working level as is well known in the art. A mode valve 40 is placed as shown in the figures and mode valve 40, may be set as in FIG. 1, to deliver the air pressure and flow to a vacuum inductor 50, preferably of the Venturi principal type as shown, so as to produce suction in the system. The mode valve 40 may alternatively be placed as shown in FIG. 3 so as to deliver air pressure and flow to the system rather than suction.

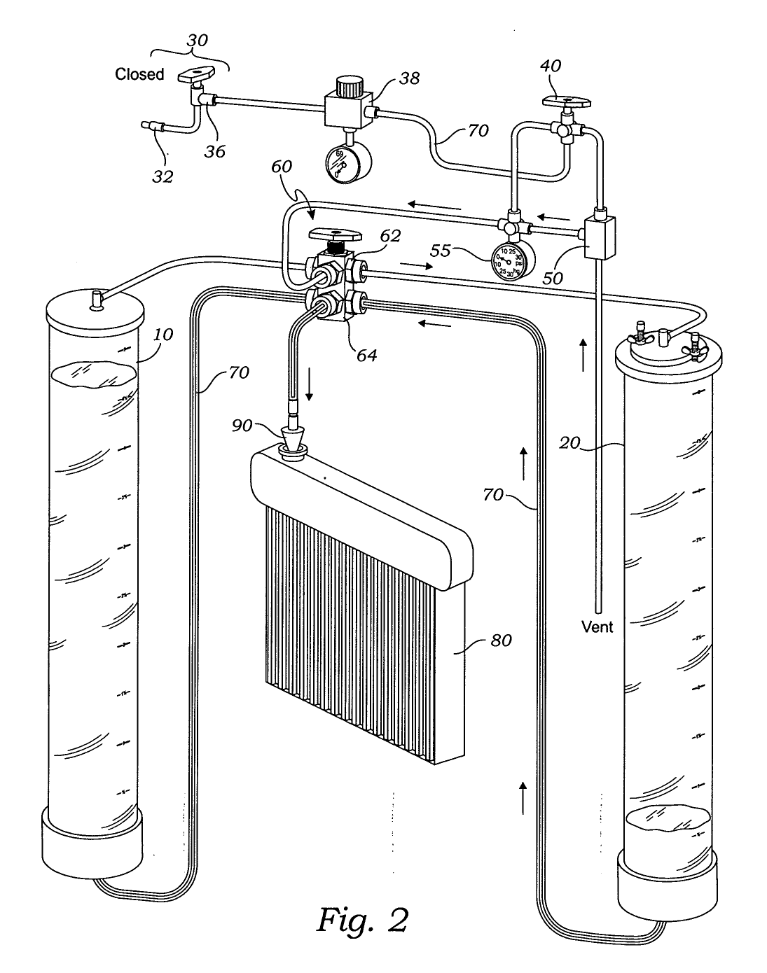

Attention is drawn to the dual valve set 60, which, in general, may be an assembly of more than two valves as desired. However, in the present example, the dual valve set 60 provides the function necessary to achieve the objectives previously described. It should be noticed that valve set 60, when its handle is in the first position shown in FIGS. 1 or 3, enables fluid flow between the left conduit and the center conduit respectively for both the A-valve and the B-valve, while with the handle set in the further position shown in FIG. 2, fluid flow is enabled between the right conduit and the center conduit, again, for both the A-valve and the B-valve. This fluid switching function and its importance will become apparent from the further description below.

Now, with the mode valve 40 in its first position, and the dual valve set in its initial position as shown in FIG. 1, air flow introduced at the air inlet 30 is conducted through the vacuum inductor 50 establishing suction at the receiver tank 10 through the A-valve 62, and thereby drawing fluid from the working fluid tank 80, which may be an automotive radiator or similar tank, into the receiver tank 10 through the B-valve 64. Sealing fixture 90, a conical-shaped rubber stopper through which conduction means 70 extends, enables a vacuum to be formed within the working fluid tank 80 as fluid is drawn from it. The arrows in the figures show the direction of flow in the system.

Once this fluid transfer has been accomplished, the dual valve set 60 is placed into its further position, as shown in FIG. 2 (see the valve handle in FIGS. 1 and 2), after the air inlet valve 36 is closed. Now, ambient air is drawn into the system through the vent pipe of inductor 50 and conducted to the discharge tank 20 through the A-valve; thereby enabling fluid from the discharge tank 20 to flow into the working fluid tank 80 through the B-valve due to vacuum suction from the tank 80. It should be clear that in this step the motive force for moving fluid from tank 20 to tank 80 is not outside air pressure, and it is not suction developed at inductor 50, but rather it is the low pressure (vacuum) condition left in tank 80 after removing its fluid. To accomplish this, tank 80 would have to be fully sealed including the advantageous use of sealing fixture 90.

In the present example the application involves drawing spent radiator coolant fluid from an automotive radiator (tank 80), and replacing it with new radiator coolant fluid. However, one of skill will find other obvious applications for the present apparatus and method.

When necessary to discharge the spent fluid in the receiver tank 10 in preparation of further fluid cycling, as described above, the mode valve 40 is placed in its second position, and the dual valve set 60 is placed in its initial position, as shown in FIG. 3, so as to deliver pressurized air through the inlet valve 36 to direct fluid from the receiver tank 10 into a collection tank 100.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. A fluid exchange apparatus comprising: a receiver tank, a discharge tank; an air inlet, a mode valve, a vacuum inductor, a dual valve set having an A-valve conductive between alternative first flow paths, and a B-valve conductive between alternative second flow paths, the A-valve and the B-valve joined to move between the first and second alternative flow paths simultaneously, and a conduit means joining the components such that with the mode valve in a first position thereof, and the dual valve set in an initial position thereof, air flow introduced at the air inlet is conducted through the vacuum inductor thereby establishing suction at the receiver tank through the A-valve, and thereby drawing fluid from a working fluid tank into the receiver tank through the B-valve; and with the dual valve set in a further position, air flow introduced at the air inlet is conducted to the discharge tank through the A-valve; thereby driving fluid from the discharge tank to the working fluid tank through the B-valve.

2. The apparatus of claim 1 further comprising a sealing fixture engaged with the conduit means at the working fluid tank, thereby establishing a pressure seal between the conduit means and a port of the working fluid tank.

3. The apparatus of claim 1 wherein with the mode valve in a second position and the dual valve set in the initial position air flow is directed to the receiver tank for driving fluid to a collection tank.

4. A fluid exchange apparatus comprising: plural tanks; a source pressurized fluid, a source of suction, a dual valve set having an A-valve conductive between alternative first flow paths, and a B-valve conductive between alternative second flow paths, the A-valve and the B-valve joined to move between the first and second alternative flow paths simultaneously, and a conduit means joining the components such that with the dual valve set in a first position, the source of suction is directed through the A-valve to one of the tanks, to draw fluid from a further one of the tanks into the one of the tanks through the B-valve, leaving a partial vacuum in the further one of the tanks; and with the dual valve set in a second position, fluid is sucked out of a still further one of the tanks into the further one of the tanks through the B-valve while the still further one of the tanks is vented through the A-valve.

5. The apparatus of claim 4 further comprising a sealing fixture engaged with the conduit means at the further one of the tanks, thereby establishing a pressure seal between the conduit means and a port of the further one of the tanks.

6. The apparatus of claim 1 wherein with the source of pressure is directed through to drive fluid therefrom through the B-valve to a collection tank.

7. A fluid exchange apparatus for exchanging fluid in a tank, the apparatus comprising: a dual valve set having an A-valve conductive between alternative first flow paths, and a B-valve conductive between alternative second flow paths, the A-valve and the B-valve joined to move between the first and second alternative flow paths simultaneously, and a conduit means joining the dual valve set with the tank; the conduit means arranged for establishing suction at the tank with the dual valve set in a first position wherein the suction is directed through the A-valve to draw fluid from the tank through the B-valve, leaving a partial vacuum in the tank; and with the dual valve set in a second position, to draw a replacement fluid into the tank through the B-valve while providing a venting function through the A-valve.
